(19) United States
(12) Patent Application Publication
(10) Pub. No.: US 2023/0356030 A1
(43) Pub. Date: Nov. 9, 2023

(54) INTELLIGENT FITNESS DEVICE AND METHOD FOR UPDATING POSITION OF THE INTELLIGENT FITNESS DEVICE

(71) Applicant: CHENGDU FIT-FUTURE TECHNOLOGY CO., LTD., Chengdu (CN)

(72) Inventors: Bowen ZHANG, Chengdu (CN); Weitao XI, Chengdu (CN)

(73) Assignee: CHENGDU FIT-FUTURE TECHNOLOGY CO., LTD., Chengdu (CN)

(21) Appl. No.: 18/045,521

(22) Filed: Oct. 11, 2022

(30) Foreign Application Priority Data
May 7, 2022 (CN) 202210490045.6

(51) Int. Cl. A63B 24/00; A63B 71/00; A63B 21/005; A63B 21/00

(52) U.S. Cl. CPC A63B 24/0062; A63B 71/0054; A63B 21/0058; A63B 21/153; A63B 2071/0072; A63B 2220/13; A63B 2220/833

(57) ABSTRACT

An intelligent fitness device and method for updating a position of the intelligent fitness device, which involves the field of intelligent fitness. The method includes: obtaining initial position data of the motor and the first spool, performing a zero setting on the initial position data, obtaining real-time position data of the motor and the first spool, calculating pull-out distances of the motor and the first spool based on the initial position data and the real-time position data, updating the first pull-out distance based on moving speeds of the motor and the first spool, or the real-time position data of the motor and the first spool, and finally, based on the updated distance, calculating the pull-out distance of the second spool.

### CROSS-REFERENCE TO RELATED APPLICATION

This application claims priority of Chinese Patent Application No. 202210490045.6, filed on May 7, 2022, the contents of which are entirely incorporated herein by reference.

### TECHNICAL FIELD

The present disclosure involves the field of intelligent fitness and specifically, involves an intelligent fitness device and method for updating a position of the intelligent fitness device.

### BACKGROUND

The working principle of the intelligent fitness device: the intelligent fitness device includes a motor, a differential, a support arm, a pull rope, a controller, a circuit, and an accessory. A spool is connected between a motor output shaft and the differential. One end of the pull rope is connected with the differential, and the other end of the pull rope is connected with a pull ring or other fitness accessories. A user may exercise by pulling the pull rope or using the support arm. When the motor is powered on, it may generate an output torque, that is, a resistance. A user needs to overcome the output torque of the motor when pulling the pull rope and the output torque is controlled by controlling the motor, so as to achieve the purpose of strength training.

The above fitness device may be used to carry out a variety of strength training to help the user complete strength training of different types and intensities, but in the actual use process of the above fitness device, due to the resistance between the motor output shaft and the spool as well as the existence of the differential, a deviation of the pull-out distance of the spool in actual operation may occur, resulting in a shaking of the spool, which brings certain safety hazards to the training.

### SUMMARY

To improve a stability and safety of the above intelligent fitness device, the present disclosure provides a method for updating a position of an intelligent fitness device.

To achieve the above purpose, the present disclosure provides a method for updating a position of an intelligent fitness device, which is applied to the intelligent fitness device, the intelligent fitness device including a motor, a first spool, and a second spool, wherein the method comprises the following operations:
obtaining first initial position data of the motor and a first change value of the first initial position data at an adjacent moment, and obtaining second initial position data of the first spool and a second change value of the second initial position data at the adjacent moment;
determining whether the first change value is greater than a first threshold, and in response to the determination that the first change value is greater than the first threshold, resetting the first initial position data of the motor; determining whether the second change value is greater than the first threshold, and in response to the determination that the second change value is greater than the first threshold, resetting the second initial position data of the first spool;
in response to the determination that the first change value and the second change value are smaller than the first threshold, obtaining first real-time position data of the motor and second real-time position data of the first spool;
calculating a first pull-out distance of the motor based on the first initial position data and the first real-time position data, and calculating a second pull-out distance of the second spool based on the second initial position data and the second real-time position data;
based on a moving speed of the motor and a moving speed of the first spool, or the first real-time position data of the motor and the second real-time position data of the first spool, updating the first pull-out distance and obtaining a third pull-out distance, and updating the second pull-out distance and obtaining a fourth pull-out distance;
calculating, based on the third pull-out distance and the fourth pull-out distance, a pull-out distance of the second spool.

The principle of the present disclosure is that: when a user uses the intelligent fitness device, to calculate the pull-out distances of the motor and the first spool, the first initial position data of the motor, the second initial position data of the first spool, the first real-time position data of the motor, and the second real-time position data of the first spool need to be obtained. When obtaining the first initial position data and the second initial position data, it is necessary to determine whether a floating range of the first initial position data and the second initial position data at adjacent moments exceeds a preset range, in response to the determination that the floating range exceeds the preset range, it means that the motor and the first spool are floating. At this time, the first initial position data and the second initial position data needs to be reset, and then based on the obtained initial position data and real-time position data, the first pull-out distance of the motor and the second pull-out distance of the first spool may be calculated. Since the moving speed or the real-time position data of the motor and the first spool may affect the pull-out distance of the motor and the first spool, the first pull-out distance needs to be corrected and updated to obtain the third pull-out distance, and the second pull-out distance needs to be corrected and updated to obtain the fourth pull-out distance. Finally, the pull-out distance of the second spool may be accurately calculated based on the third pull-out distance and the fourth pull-out distance. Thereby, a shaking of the spool during operation can be reduced, and the stability and safety of the intelligent fitness device can be improved.

Preferably, in the method, the first pull-out distance of the motor and the second pull-out distance of the first spool are calculated by the following formulas:

the first pull-out distance=the first real-time position data−the first initial position data, and

the second pull-out distance=the second real-time position data−the second initial position data.

Where, a difference between the real-time position data and the initial position data of the motor is the pull-out distance of the motor, and a difference between the real-time position data and the initial position data of the first spool is the pull-out distance of the first spool. Through the above formulas, the pull-out distances of the first spool and the motor can be accurately calculated.

Preferably, in the method, determining whether the first real-time position data is greater than the first initial position data; in response to the determination that the first real-time position data is greater than the first initial position data, calculating the first pull-out distance; or in response to the determination that the first real-time position data is not greater than the first initial position data, determining the first pull-out distance as zero; and determining whether the second real-time position data is greater than the second initial position data; in response to the determination that the second real-time position data is greater than the second initial position data, calculating the second pull-out distance; or in response to that the second real-time position data is not greater than the second initial position data, determining the second pull-out distance as zero.

The set of the above condition is for explain that the values of the pull-out distances of the first spool and the motor are always non-negative numbers.

Preferably, in the method, the updating the first pull-out distance of the motor and the second pull-out distance of the first spool specifically includes:
obtaining a first average value of a moving distance of the motor within a first preset time, and updating the first initial position data of the motor if the first average value is less than the first initial position data of the motor; and
obtaining a second average value of a moving distance of the first spool within the first preset time, and updating the second initial position data of the first spool if the second average value is less than the second initial position data of the first spool; or
determining whether the first real-time position data of the motor and the second real-time position data of the first spool satisfies a preset condition, and in response to the determination that the second real-time position data of the first spool satisfies a preset condition, updating the first initial position data and the second initial position data.

The average value of the moving distance of the motor and the first spool within a preset time, or the real-time position data of the motor and the first spool may both affect the pull-out distances of the motor and the first spool. The correction and the updating may be performed on the pull-out distances of the motor and the first spool based on the above determination conditions.

Preferably, in the method, the determining whether the first real-time position data of the motor and the second real-time position data of the first spool satisfy preset conditions specifically includes the following two conditions:
condition one: obtaining a first difference value of the first real-time position data of the motor at an adjacent moment, and a second difference value of the second real-time position data of the first spool at the adjacent moment, the first difference value and the second distance value both within a preset range;
condition two: the time when condition one is satisfied exceeds a second preset time; and
the first initial position data of the motor and the second initial position data of the first spool are updated when both condition one and two are satisfied.

The above conditions are set to determine whether the real-time positions of the motor and the first spool are floating, if at adjacent moments, a difference between the real-time position data of the motor and the first spool is within a preset range and remains longer than the preset time, it means that the real-time position of the motor and the first spool are not floating, and the first initial position data and the second initial position data may be updated.

Preferably, in the method, the pull-out distance of the second spool may be calculated by the following formula:

the pull-out distance of the second spool=the third pull-out distance of the motor−the fourth pull-out distance of the first spool.

Where, the pull-out distance of the second spool is a difference between the third pull-out distance of the motor and the fourth pull-out distance of the first spool.

The present disclosure further provides an intelligent fitness device, including: a motor, a a first spool, a second spool, at least one processor, and one or more memories coupled to the at least one processor and storing programming instructions for execution by the at least one processor to:
obtain first initial position data of the motor and a first change value of the first initial position data at an adjacent moment, and obtain second initial position data of the first spool and a second change value of the second initial position data at the adjacent moment;
determine whether the first change value is greater than a first threshold, and in response to the determination that the first change value is greater than the first threshold, reset the first initial position data of the motor; and determine whether the second change value is greater than the first threshold, and in response to the determination that the second change value is greater than the first threshold, reset the second initial position data of the first spool;
in response to the determination that the first change value and the second change value are smaller than the first threshold, obtain first real-time position data of the motor and second real-time position data of the first spool;
calculate a first pull-out distance of the motor based on the first initial position data and the first real-time position data, and calculate a second pull-out distance of the second spool based on the second initial position data and the second real-time position data;
based on a moving speed of the motor and a moving speed of the first spool, or the first real-time position data of the motor and the second real-time position data of the first spool, update the first pull-out distance and obtain a third pull-out distance, and update the second pull-out distance and obtain a fourth pull-out distance; and
calculate, based on the third pull-out distance and the fourth pull-out distance, a pull-out distance of the second spool.

Preferably, the first pull-out distance of the motor and the second pull-out distance of the first spool are calculated by the following formulas:

the first pull-out distance=the first real-time position data−the first initial position data, and

the second pull-out distance=the second real-time position data−the second initial position data.

One or more memories coupled to the at least one processor and storing programming instructions for execution by the at least one processor to determine whether the first real-time position data is greater than the first initial position data; in response to the determination that the first real-time position data is greater than the first initial position data, calculate the first pull-out distance; or in response to the determination that the first real-time position data is not greater than the first initial position data, determine the first pull-out distance as zero; and determine whether the second real-time position data is greater than the second initial position data; in response to the determination that the second real-time position data is greater than the second initial position data, calculate the second pull-out distance; or in response to that the second real-time position data is not greater than the second initial position data, determine the second pull-out distance as zero.

The programming instructions are for execution by the at least one processor to:
obtain a first average value of a moving distance of the motor within a first preset time, and update the first initial position data of the motor if the first average value is less than the first initial position data of the motor; and
obtain a second average value of a moving distance of the first spool within the first preset time, and update the second initial position data of the first spool if the second average value is less than the second initial position data of the first spool; or
determine whether the first real-time position data of the motor and the second real-time position data of the first spool satisfies a preset condition, and in response to the determination that the second real-time position data of the first spool satisfies a preset condition, update the first initial position data and the second initial position data.

The preset conditions includes:
condition one: obtaining a first difference value of the first real-time position data of the motor at an adjacent moment, and a second difference value of the second real-time position data of the first spool at the adjacent moment, the first difference value and the second distance value both within a preset range;
condition two: the time when condition one is satisfied exceeds a second preset time; and
the first initial position data of the motor and the second initial position data of the first spool are updated when both condition one and two are satisfied.

The pull-out distance of the second spool may be calculated by the following formula:

the pull-out distance of the second spool=the third pull-out distance of the motor−the fourth pull-out distance of the first spool.

The one or more technical solutions provided by the present disclosure at least include the following technical effects or advantages.

Through updating the positions of the motor and the spool of the intelligent fitness device, the shaking of the spool in its operation can be reduced, thereby improving the stability of the intelligent fitness device, and ensuring the safety of users when using the intelligent fitness device.

### BRIEF DESCRIPTION OF THE DRAWINGS

The attached drawings described here are used to provide further understanding of the embodiments of the present disclosure, which constitutes part of the present disclosure, and does not constitute a limit on the embodiments of the present disclosure:

FIG. 1 is a flowchart illustrating a method for updating a position of an intelligent fitness device according to the present disclosure; and

FIG. 2 is a schematic diagram illustrating a system for updating a position of an intelligent fitness device according to the present disclosure.

### DETAILED DESCRIPTION

In order to be able to understand the above objects, features, and advantages of the present disclosure more clearly, the present disclosure may be further described in detail below with reference to the accompanying drawings and specific embodiments. It should be noted that the embodiments of the present disclosure and the features in the embodiments may be combined with each other under the condition that they do not conflict with each other.

Many specific details are set forth in the following description to facilitate a full understanding of the present disclosure. However, the present disclosure may also be implemented in other ways that are different from the scope of this description. Therefore, the protection scope of the present disclosure is not subject to the limitations of the specific embodiments of the following disclosure.

### Embodiment 1

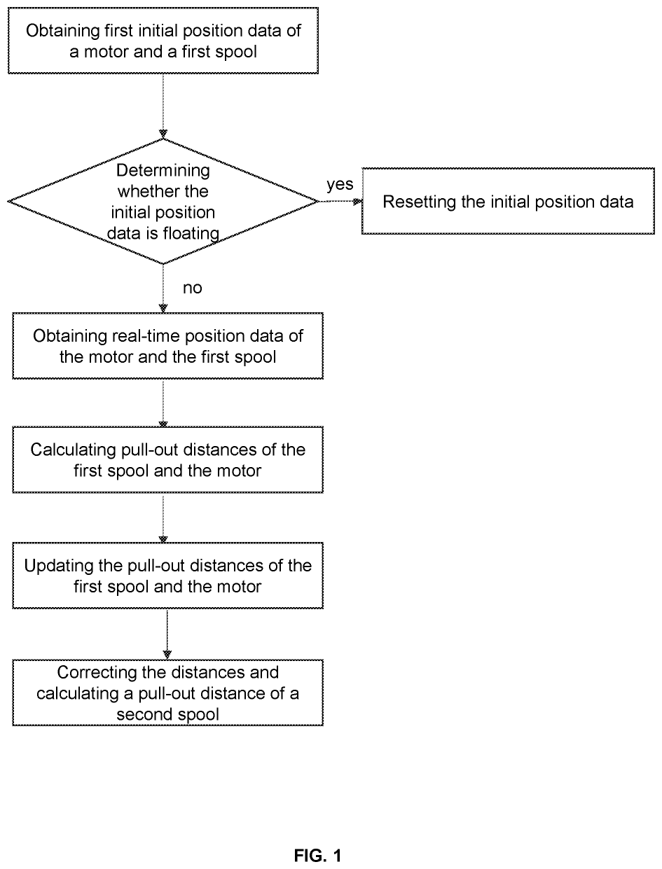

Please refer to FIG. 1, FIG. 1 is a flowchart illustrating a method for updating a position of an intelligent fitness device. The embodiment provides the method for updating a position of an intelligent fitness device. The method is applied to the intelligent fitness device, including a motor, a first spool and a second spool. The method includes:
obtaining first initial position data of the motor and a first change value of the first initial position data at an adjacent moment, and obtaining second initial position data of the first spool and a second change value of the second initial position data at the adjacent moment (The first initial position data is 3, the first change value is 2, the second initial position data is 4, the second change value is 1, and the adjacent moment may be in each adjacent second. In practical applications, the above data may be flexibly adjusted as needed, and the present disclosure does not make specific limitations on this);
determining whether the first change value is greater than a first threshold (The first threshold is, e.g., 5. In practical application, the first threshold may be flexibly adjusted as needed, and the present disclosure does not make specific limitations on this); in response to the determination that the first change value is greater than the first threshold, resetting the first initial position data of the motor, and determining whether the second change value is greater than the first value, in response to the determination that the second change value is greater than the first threshold, resetting the second initial position data of the first spool;
in response to the determination that the first change value and the second change value are smaller than the first threshold, obtaining first real-time position data of the motor and second real-time position data of the first spool (The first change value 2 is less than the first threshold value 5, and the second change value 1 is less than the first threshold value 5. At this time, the obtained first real-time position data is 10, and the second real-time position data is 8. In practical applications, the above data may be flexibly adjusted according to needs, and the present disclosure does not make specific limitations on this);
calculating a first pull-out distance of the motor based on the first initial position data and first real-time position data, and calculating a second pull-out distance of the second spool based on the second initial position data and second real-time position data (The first initial position data is 3, the first real-time position data is 10, the second initial position data is 4, the second real-time position data is 8, and then the first pull-out distance is calculated as 7 and the second pull-out distance is 4. In practical applications, the above data may be flexibly adjusted according to needs, and the present disclosure does not make specific limitations on this);
based on a moving speed of the motor and a moving speed of the first spool, or the first real-time position data of the motor and the second real-time position data of the first spool, updating the first pull-out distance and obtaining a third pull-out distance, and updating the second pull-out distance and obtaining a fourth pull-out distance (The third pull-out distance is obtained as 8, and obtaining the fourth pull-out distance is obtained as 6. In practical applications, the above data may be flexibly adjusted according to needs, and the present disclosure does not make specific limitations on this);
calculating, based on the third pull-out distance and the fourth pull-out distance, a pull-out distance of the second spool (The third pull-out distance is 8, the fourth pull-out distance is 6, the pull-out distance of the second spool is calculated as 2. In practical applications, the above data may be flexibly adjusted according to needs, and the present disclosure does not make specific limitations on this).

The first initial position data of the motor and the second initial position data of the first spool may be obtained by a position sensor or an encoder installed on the motor and the first spool. The present disclosure does not limit the way that the motor and the first spool obtain the initial position data.

The first real-time position data and the second real-time position data may be obtained by the number of turns of the motor or the number of turns of the spool. The present disclosure does not limit the way in which the first real-time position data and the second real-time position data are obtained.

Moving speed data of the motor may be obtained from a rotation speed of the motor, and moving speed data of the first spool may be obtained from the rotation speed of the spool. The present disclosure does not limit the way in which the motor and the first spool obtain the moving speed data.

In the embodiments of the present disclosure, controlling the motor in the intelligent fitness device includes: issuing a command to a motor control board through a host computer. The motor control board may be used to control the motor in the intelligent fitness device.

To reset the first initial position data of the motor and the second initial position data of the first spool, that is, to set the motor to zero, the following approaches may be used to perform the zero setting. A DC power supply may be used to apply a DC current less than a rated current to a UV winding of the motor, U phase in, V phase out, and a motor shaft may be oriented to a balanced position. A U-phase signal and a Z zero-position signal of the encoder may be observed with an oscilloscope. A relative position of the encoder's shaft and the motor shaft may be adjusted; meanwhile, a transition edge of the U-phase signal of the encoder and the Z zero-position signal may be observed until the Z zero-position signal is stable at a high level (the default Z zero-position signal is at a low level), and a relative position relation of the encoder and the motor may be locked. The motor shaft may be turned back and forth, and if the Z zero-position signal may be stabilized at a high level every time the motor shaft freely returns to a balanced position, the zero setting is valid. The motor may further use a mechanical zero setting, and the present disclosure does not limit the approaches of zero setting of the motor.

The first pull-out distance of the motor and the second pull-out distance of the first spool may be calculated by the following formulas:

the first pull-out distance=the first real-time position data−the first initial position data;

the second pull-out distance=the second real-time position.

If the first real-time position data is greater than the first initial position data, the first pull-out distance may be calculated, and if the first real-time position data is less than or equal to the first initial position data, the first pull-out distance may be zero (for example, the first real-time position data is 12 and the first initial position data is 2, then the first pull-out distance may be calculated to be 10; for another example, the first real-time position data is 1 and the first initial position data is 3, then the first pull-out distance may be calculated to be 0. The above data is only an explanation of the formula. In practical applications, the data may be flexibly adjusted according to needs, and the present disclosure does not make specific limitations on this). If the second real-time position data is greater than the second initial position data, the second pull-out distance may be calculated, and if the second real-time position data is less than or equal to the second initial position data, the second pull-out distance may be zero (for example, the second real-time position data is 14 and the second initial position data is 2, then the second pull-out distance may be calculated to be 12; for another example, the second real-time position data is 2 and the second initial position data is 4, then the second pull-out distance may be calculated to be 0. The above data is only an explanation of the formula. In practical applications, the data may be flexibly adjusted according to needs, and the present disclosure does not make specific limitations on this).

The first pull-out distance and the second pull-out distance may be updated, the updating process specifically includes: obtaining a first average value of the moving distance of the motor within a preset time, that is, obtaining moving speed data of the motor, which may be obtained through the rotation speed of the motor. If the first average value is less than the first initial position data, the first initial position data may be updated (For example, the preset time is one second, the first average value is 2, the first initial position data is 3, at this time, the first average value is smaller than the first initial position data, then the first initial position data may be updated to 2. In practical applications, the above data may be flexibly adjusted according to needs, and the present disclosure does not make specific limitations on this); obtaining a second average value of the moving distance of the first spool within the preset time, that is, obtaining the speed data of the first spool, the moving speed data of the first spool may be obtained through a rotation speed of the first spool. If the second average value is less than the second initial position data, the second initial position data may be updated (for example, the preset time is one second, the second average value is 4, the second initial position data is 5, at this time, the second average value is smaller than the second initial position data, then the second initial position data may be updated to be 4. In practical applications, the above data may be flexibly adjusted according to needs, and the present disclosure does not make specific limitations on this). Or, at adjacent moments, a difference between the real-time position data of the motor and the first spool is within a preset range and remains longer than the preset time, then updating the first initial position data and the second initial position data (For example, the adjacent time is one second, the preset range is 5, the preset time is 2 minutes, the initial position data of the motor is 2, the real-time position data of the motor is 4, and the initial position data of the first spool is 3, the real-time position data of the first spool is 6, the difference between the real-time position data of the motor in adjacent one second is 2 and it remains for more than 2 min, and the difference between the real-time position data of the first spool in adjacent one second is 3 and it remains for more than 2 min. At this time, the differences between the real-time position data of the motor and the first spool are both smaller than the preset range and remains longer than the preset time, then the real-time position data of the motor may be used as initial position data of the motor, the real-time position data of the first spool may be used as initial position data of the first spool. In practical applications, the above data may be flexibly adjusted according to needs, and the present disclosure does not make specific limitations on this). The first initial position data and the second initial position data may be updated, the initial position data after the update still satisfies the formula: the pull-out distance=the real-time position data−the initial position data, so that the purpose of updating the first pull-out distance and the second pull-out distance may be achieved.

The pull-out distance of the second spool may be calculated through the following formula:

the pull-out distance of the second spool=the third pull-out distance of the motor−the fourth pull-out distance of the first spool.

If the third pull-out distance of the motor has not been updated, the value of the third pull-out distance may be equal to the value of the first pull-out distance; if the fourth pull-out distance of the first spool has not been updated, the value of the fourth pull-out distance may be equal to the value of the second pull-out distance, that is, the pull-out distance of the second spool always satisfies the formula: the pull-out distance of the second spool=the pull-out distance of the motor−the pull-out distance of the first spool. (For example, the third pull-out distance of the motor is 8, and the fourth pull-out distance of the first spool is 3, then the calculated pull-out distance of the second spool is 5. The above data is only to explain the formula, the above data may be flexibly adjusted according to needs, and the present disclosure does not make specific limitations on this).

In this embodiment, the user may perform an impedance motion by pulling the pull rope at the end of the support arm, and the position data of the motor and the first spool may be obtained through the position sensor of the motor and the first spool, and the obtained position data may be fed back to the host computer. The host computer calculates and corrects the obtained position data, and then issues the corresponding command to the motor control board to control the operation of the motor, thereby improving the stability of the spool during operation and ensuring the safety of the user when using the intelligent fitness device. A double sensor may be used to detect the motor position, including an optical encoder and a photoelectric position sensor, the optical encoder is used to detect the position of the first spool, and the photoelectric position sensor is located on the stator, and may detect the motor position, correct, and monitor the optical encoder. In practical applications, the optical encoder and the photoelectric position sensor may be replaced by other sensors with the same or similar functions. The present disclosure does not limit the specific types and models of the above devices. The motor control board may choose a motor starter, an intelligent controller, or a servo controller, preferably a servo controller. The servo controller has the following advantages: a wide speed range, a high positioning accuracy, a sufficient transmission rigidity and a high-speed stability, a quick response, no overshoot, low speed and large torque, strong overload capacity and high reliability.

### Embodiment Two

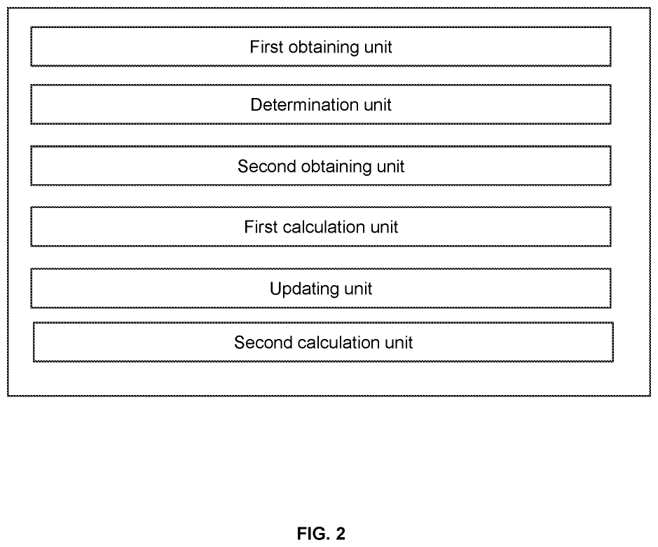

Please refer to FIG. 2, the embodiment of the present disclosure provides a system for updating a position of an intelligent fitness device. The intelligent fitness device includes a motor, a first spool and a second spool. The system further includes:
a first obtaining unit configured to obtain first initial position data of the motor and a first change value of the first initial position data at an adjacent moment, and obtain second initial position data of the first spool and a second change value of the second initial position data at the adjacent moment;
a determination unit configured to determine whether the first change value is greater than a first threshold, in response to the determination that the first change value is greater than the first threshold, reset the first initial position data of the motor, and determine whether the second change value is greater than the first threshold, in response to the determination that the second change value is greater than the first threshold, reset the second initial position data of the first spool;
a second obtaining unit configured to obtain first real-time position data of the motor and second real-time position data of the first spool in response to the determination that the first change value and the second change value are smaller than the first threshold.
a first calculation unit configured to calculate, based on the first initial position data and the first real-time position data, a first pull-out distance of the motor, and calculate, based on the second initial position data and the second real-time position data, a second pull-out distance of the second spool;
an updating unit configured to, based on a moving speed of the motor and the moving speed of the first spool, or the first real-time position data of the motor and the second real-time position data of the first spool, update the first pull-out distance and obtain a third pull-out distance, and update the second third pull-out distance and obtain a fourth pull-out distance;
a second calculation unit configured to calculate, based on the third pull-out distance and the fourth pull-out distance, a pull-out distance of the second spool.

The first calculation unit uses the following formula to calculate the first pull-out distance and the second pull-out distance:

the first pull-out distance=the first real-time position data−the first initial position data.

the second pull-out distance=the second real-time position data−the second initial position data.

### Embodiment Three

The embodiment of the present disclosure provides a device for updating a position of an intelligent fitness device, including a memory, a processor, and a computer program stored in the memory and running on the processor, when executing the computer program, the processor implements the method for updating a position of an intelligent fitness device.

The processor may be a central processor unit (CPU), or other general processor, digital signal processor, application special integrated circuit), field programmable gate array, or other programmable logic device, discrete gate or transistor logic device, discrete hardware component, etc. The general processor may be a microprocessor or any regular processor.

The memory may be configured to store the computer program and/or module, and the processor may implement various functions of the device for updating the position of the intelligent fitness device of the present disclosure by running or executing the data stored in the memory. The memory may mainly include the storage program area and the storage data area. Among them, the storage program area can store the operating system, at least one function required for applications (such as sound playback function, image playback function, etc.). In addition, the memory may include a high-speed random-access memory, and may further include a non-volatile memory such as a hard disk, an internal memory, a plug-in hard disk, a smart memory card, a secure digital card, a flash memory card, at least one magnetic disk storage device, a flash memory device, or other volatile solid state memory devices.

### Embodiment Four

The embodiment of the present disclosure provides a computer-readable storage medium storing computer instructions, when executing the computer instructions in the storage medium, a processor implements the method for updating a position of an intelligent fitness device.

When the device for updating the position of the intelligent fitness device is implemented in the form of a software functional unit and is sold or used as an independent product, the device may be stored in a computer-readable storage medium. Based on this understanding, the present disclosure implements all or part of the processes in the methods of the above embodiments, and the methods may further be stored in the computer-readable storage medium through the computer program. When executing the computer program, the processor implements the operations of the embodiments of the method. The computer program includes a computer program code, an object code form, an executable file, or some intermediate forms, etc. The computer-readable medium may include: any entity or device capable of carrying the computer program code, a recording medium, a U disk, a removable hard disk, a magnetic disk, an optical disk, a computer memory, a read-only memory, a random-access memory, a point carrier signal, a telecommunication signal, and a software distribution media, etc. It should be noted that the content contained in the computer-readable medium may be appropriately increased or decreased in accordance with the requirements of legislation and patent practice in the jurisdiction.

The present disclosure has described the basic concept. Obviously, for those skilled in the art, the above detailed disclosure is only used as an example, and it does not constitute a limitation of the present disclosure. Although not explicitly described herein, various modifications, improvements, and corrections to this disclosure may occur to the those skilled in the art. Such modifications, improvements, and corrections are suggested in this disclosure and thereof remain within the spirit and scope of the exemplary embodiments of this disclosure.

Meanwhile, the present disclosure uses specific words to describe the embodiments of the present disclosure. For example, “one embodiment,” “an embodiment,” and/or “some embodiments” mean that a certain feature, structure, or characteristic is connected with at least one embodiment of the present disclosure. Therefore, it is emphasized and should be appreciated that two or more references to “an embodiment” or “one embodiment” or “an alternative embodiment” in various parts of this disclosure are not necessarily all referring to the same embodiment. Furthermore, the particular features, structures, or characteristics may be combined as suitable in one or more embodiments of the present disclosure.

Moreover, those skilled in the art will appreciate that various aspects of the present specification may be illustrated and described by certain patented types or situations, including any new and useful steps, machines, products, or materials, or them Any new and useful improvements. Correspondingly, all aspects of the present disclosure may be fully executed by a hardware, may be fully executed by software (including firmware, resident software, microcodes, etc.), or may further be performed by both hardware and software. The above hardware or software may be referred to as “data block”, “module”, “engine”, “unit”, “component” or “system”. Moreover, aspects of the present disclosure may be manifested as a computer product in one or more computer readable media, which includes computer readable program encoding.

The computer storage medium may contain a transmission data signal containing a computer program coding, such as on the baseband or as part of the carrier. There may be a variety of expression forms, including electromagnetic forms, light forms, etc., or a suitable combination form. The computer storage medium may be any computer readable medium except the computer readable medium. This medium can be connected to an instruction execution system, equipment, or device to achieve communication, dissemination, or transmission procedures. Program encoding on a computer storage medium can be propagated by any suitable medium, including radio, cables, fiber optic cables, RF, or similar media, or any of the above media.

The computer program code required for the operation of each part of this manual may be written in any one or more programming languages, including object-oriented programming languages such as Java, Scala, Smalltalk, Eiffel, JADE, Emerald, C++, C #, VB.NET, Python, etc., and conventional programming languages such as C language, Visual Basic, Fortran 2003, Perl, COBOL 2002, PHP, ABAP, dynamic programming languages such as python, ruby and groovy, or other programming languages. The program code may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, unless explicitly stated in the claims, the order of processing elements and sequences described in this disclosure, the use of alphanumeric, or the use of other names is not intended to limit the order of the processes and methods of this disclosure. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be noted that, in order to simplify the expressions disclosed in this disclosure and thus help the understanding of one or more embodiments of the present disclosure, in the foregoing description of the embodiments of this disclosure, various features may sometimes be combined into one embodiment, in the drawings or descriptions thereof. The method of the present disclosure, however, is not to be interpreted as reflecting an intention that the claimed object matter requires more features than are expressly recited in each claim. Rather, claimed subject matter may lie in less than all features of a single foregoing disclosed embodiment.

For each patent, patent application, patent application publication, and other material, such as an article, a book, a specification, a publication, a document, etc., cited in this disclosure, the entire contents are hereby incorporated into this disclosure for reference, except for application history documents that are inconsistent with or conflict with the contents of the present disclosure, and documents (currently or later appended to the present disclosure) limiting the broadest scope of the claims of the present disclosure are also excluded. It should be noted that, if there is any inconsistency or conflict between the descriptions, definitions and/or use of terms in the accompanying materials of this disclosure and the contents of this disclosure, the descriptions, definitions and/or use of terms in this disclosure shall prevail.

Finally, it should be understood that the embodiments described in the present disclosure are only intended to illustrate the principles of the embodiments of this disclosure, other deformations may also belong to the scope of the present disclosure. Accordingly, by way of example and not limitation, alternative configurations of the embodiments of this disclosure may be consistent with the instruction of this disclosure. Accordingly, the embodiments of this disclosure are not limited to those expressly introduced and described in this disclosure.

Although preferred embodiments of the present disclosure have been described, additional changes and modifications to these embodiments may occur to those skilled in the art once the basic inventive concepts are known. Therefore, the appended claims are intended to be construed to include the preferred embodiment and all changes and modifications that fall within the scope of the present disclosure.

It will be apparent to those skilled in the art that various modifications and variations may be made in the present disclosure without departing from the spirit and scope of the disclosure. Thus, provided that these modifications and variations of the present disclosure fall within the scope of the claims of the present disclosure and their equivalents, the present disclosure is also intended to include these modifications and variations.

What is claimed is:

1. A method for updating a position of an intelligent fitness device, which is applied to the intelligent fitness device, the intelligent fitness device including a motor, a first spool, and a second spool, wherein the method comprises the following operations:
obtaining first initial position data of the motor and a first change value of the first initial position data at an adjacent moment, and obtaining second initial position data of the first spool and a second change value of the second initial position data at the adjacent moment;
determining whether the first change value is greater than a first threshold, and in response to the determination that the first change value is greater than the first threshold, resetting the first initial position data of the motor;
determining whether the second change value is greater than the first threshold, and in response to the determination that the second change value is greater than the first threshold, resetting the second initial position data of the first spool;
in response to the determination that the first change value and the second change value are smaller than the first threshold, obtaining first real-time position data of the motor and second real-time position data of the first spool;
calculating a first pull-out distance of the motor based on the first initial position data and the first real-time position data, and calculating a second pull-out distance of the second spool based on the second initial position data and the second real-time position data;
based on a moving speed of the motor and a moving speed of the first spool, or the first real-time position data of the motor and the second real-time position data of the first spool, updating the first pull-out distance and obtaining a third pull-out distance, and updating the second pull-out distance and obtaining a fourth pull-out distance; and
calculating, based on the third pull-out distance and the fourth pull-out distance, a pull-out distance of the second spool.

2. The method of claim 1, wherein the first pull-out distance of the motor and the second pull-out distance of the first spool are calculated by the following formulas:
the first pull-out distance=the first real-time position data−the first initial position data, and
the second pull-out distance=the second real-time position data−the second initial position data.

3. The method of claim 2, wherein the calculating a first pull-out distance of the motor based on the first initial position data and the first real-time position data, and calculating a second pull-out distance of the second spool based on the second initial position data and the second real-time position data comprises:
determining whether the first real-time position data is greater than the first initial position data; in response to the determination that the first real-time position data is greater than the first initial position data, calculating the first pull-out distance; or in response to the determination that the first real-time position data is not greater than the first initial position data, determining the first pull-out distance as zero; and
determining whether the second real-time position data is greater than the second initial position data; in response to the determination that the second real-time position data is greater than the second initial position data, calculating the second pull-out distance; or in response to that the second real-time position data is not greater than the second initial position data, determining the second pull-out distance as zero.

4. The method of claim 1, wherein the updating the first pull-out distance of the motor and the second pull-out distance of the first spool specifically comprises:
obtaining a first average value of a moving distance of the motor within a first preset time, and updating the first initial position data of the motor if the first average value is less than the first initial position data of the motor; and
obtaining a second average value of a moving distance of the first spool within the first preset time, and updating the second initial position data of the first spool if the second average value is less than the second initial position data of the first spool; or
determining whether the first real-time position data of the motor and the second real-time position data of the first spool satisfies a preset condition, and in response to the determination that the second real-time position data of the first spool satisfies a preset condition, updating the first initial position data and the second initial position data.

5. The method of claim 4, wherein the preset conditions includes:
condition one: obtaining a first difference value of the first real-time position data of the motor at an adjacent moment, and a second difference value of the second real-time position data of the first spool at the adjacent moment, the first difference value and the second distance value both within a preset range;
condition two: the time when condition one is satisfied exceeds a second preset time; and
the first initial position data of the motor and the second initial position data of the first spool are updated when both condition one and two are satisfied.

6. The method of claim 1, wherein the pull-out distance of the second spool is calculated by the following formula:
the pull-out distance of the second spool=the third pull-out distance of the motor−the fourth pull-out distance of the first spool.

7. An intelligent fitness device, comprising: a motor, a first spool, a second spool; at least one processor; and one or more memories coupled to the at least one processor and storing programming instructions for execution by the at least one processor to:
obtain first initial position data of the motor and a first change value of the first initial position data at an adjacent moment, and obtain second initial position data of the first spool and a second change value of the second initial position data at the adjacent moment;
determine whether the first change value is greater than a first threshold, and in response to the determination that the first change value is greater than the first threshold, reset the first initial position data of the motor;
determine whether the second change value is greater than the first threshold, and in response to the determination that the second change value is greater than the first threshold, reset the second initial position data of the first spool;
in response to the determination that the first change value and the second change value are smaller than the first threshold, obtain first real-time position data of the motor and second real-time position data of the first spool;
calculate a first pull-out distance of the motor based on the first initial position data and the first real-time position data, and calculate a second pull-out distance of the second spool based on the second initial position data and the second real-time position data;
based on a moving speed of the motor and a moving speed of the first spool, or the first real-time position data of the motor and the second real-time position data of the first spool, update the first pull-out distance and obtain a third pull-out distance, and update the second pull-out distance and obtain a fourth pull-out distance; and
calculate, based on the third pull-out distance and the fourth pull-out distance, a pull-out distance of the second spool.

8. The intelligent fitness device of claim 7, wherein the first pull-out distance of the motor and the second pull-out distance of the first spool are calculated by the following formulas:
the first pull-out distance=the first real-time position data−the first initial position data, and
the second pull-out distance=the second real-time position data−the second initial position data.

9. The intelligent fitness device of claim 8, wherein the programming instructions are for execution by the at least one processor to:
determine whether the first real-time position data is greater than the first initial position data; in response to the determination that the first real-time position data is greater than the first initial position data, calculate the first pull-out distance; or in response to the determination that the first real-time position data is not greater than the first initial position data, determine the first pull-out distance as zero; and
determine whether the second real-time position data is greater than the second initial position data; in response to the determination that the second real-time position data is greater than the second initial position data, calculate the second pull-out distance; or in response to that the second real-time position data is not greater than the second initial position data, determine the second pull-out distance as zero.

10. The intelligent fitness device of claim 7, wherein the programming instructions are for execution by the at least one processor to:
obtain a first average value of a moving distance of the motor within a first preset time, and update the first initial position data of the motor if the first average value is less than the first initial position data of the motor; and
obtain a second average value of a moving distance of the first spool within the first preset time, and update the second initial position data of the first spool if the second average value is less than the second initial position data of the first spool; or
determine whether the first real-time position data of the motor and the second real-time position data of the first spool satisfies a preset condition, and in response to the determination that the second real-time position data of the first spool satisfies a preset condition, update the first initial position data and the second initial position data.

11. The intelligent fitness device of claim 10, wherein the preset conditions includes:
condition one: obtaining a first difference value of the first real-time position data of the motor at an adjacent moment, and a second difference value of the second real-time position data of the first spool at the adjacent moment, the first difference value and the second distance value both within a preset range;
condition two: the time when condition one is satisfied exceeds a second preset time; and
the first initial position data of the motor and the second initial position data of the first spool are updated when both condition one and two are satisfied.

12. The intelligent fitness device of claim 7, wherein the pull-out distance of the second spool is calculated by the following formula:
the pull-out distance of the second spool=the third pull−out distance of the motor the fourth pull-out distance of the first spool.
